(19) United States
(12) Patent Application Publication
(10) Pub. No.: US 2026/0360650 A1
(43) Pub. Date: Nov. 12, 2026

(54) INTEGRATED SAFETY COMPONENT FOR AN ELECTROMECHANICAL CONTACTOR

(71) Applicant: Rockwell Automation Technologies, Inc., Mayfield Heights, OH (US)

(72) Inventors: Peter J. Halpin, Fox Point, WI (US); Todd R. Sauve, Oak Creek, WI (US); David C. Mazur, Grafton, WI (US); Roberto Sampaio Marques, Mequon, WI (US); Nicholas Court, Brookfield, WI (US)

(21) Appl. No.: 19/200,090

(22) Filed: May 6, 2025

(51) Int. Cl. H01H 50/54; H01H 50/44

(52) U.S. Cl. CPC H01H 50/546; H01H 50/44

(57) ABSTRACT

Described herein are systems and techniques for an electromechanical contactor with an integrated safety component that provides safety functions impacting electrical energy transmission to a load coupled with the electromechanical contactor. The safety component, which includes components configured to achieve one of several existing safety standards (i.e., standards for functional safety of electrical, electronic, and programmable systems), is integrated into the electromechanical contactor through auxiliary connection points of the contactor. A sensor of the safety component is physically coupled with a mechanical indicator of the electromechanical contactor. The mechanical indicator moves from one physical position to another when the main conducting contacts of the electromechanical contactor change position, allowing the safety component to detect the position of the conducting contacts via the physical coupling between the mechanical indicator and the sensor. The safety component provides safety functions based on the state of the electromechanical contactor.

### BACKGROUND

Electromechanical contactors are commonly used in industrial automation environments. For example, contactors may be used in motor control centers (MCC) to provide industrial control systems with high-current switching capabilities for electric motors and various industrial loads. These devices are preferred in numerous applications due to their capacity to manage substantial currents and voltages, mechanical dependability, and well-understood operational characteristics. Some of the most robust and enduring contactors were originally developed in the 1960s and 1970s and remain substantially unchanged as leading components in the industry. However, due to various improved safety standards, many safety components may be used in conjunction with the contactors as adding safety componentry to robust, well-tested technology is preferable to many customers than pivoting to newer technologies or technologies not well proven to withstand the harsh environment and high currents the original contactors have been proven with. In some applications, contactors are implemented within the unit cabinets of MCCs that are subject to strict dimensional restrictions. To utilize the proven contactors while still conforming to safety standards and regulatory requirements, electromechanical contactors may be coupled to safety components such as auxiliary relays, safety interlocks, monitoring circuits, and similar devices.

Incorporating safety components related to electromechanical contactors into MCC unit cabinets presents several challenges. As the functional requirements of industrial control systems become increasingly sophisticated, the number and complexity of safety devices required to monitor and control contactor operations have increased. Integrating these safety systems with one or multiple electromechanical contactors leads to more intricate wiring schemes and additional assembly steps, heightening the risk of installation errors or maintenance issues.

Moreover, the physical footprint of traditional safety components can significantly impact the MCC design layout and scalability. Unit cabinets have limited internal space, and allocating sufficient room for safety modules and associated wiring and mounting hardware can restrict component placement and reduce overall system modularity. In some cases, these space limitations may necessitate compromises in safety architecture or limit the ability to incorporate redundancy or advanced monitoring functions. Accordingly, there is a need to address the challenges associated with implementing safety functionality to meet safety standards and regulations while still using proven electromechanical contactors.

### SUMMARY

Described herein are systems and techniques for an electromechanical contactor with an integrated safety component that provides safety functions impacting electrical energy transmission to a load coupled with the electromechanical contactor. The safety component, which includes components configured to achieve one of several existing safety standards (i.e., standards for functional safety of electrical, electronic, and programmable systems), is integrated with the electromechanical contactor through auxiliary connection points of the contactor. A mechanical sensor of the safety component physically (i.e., mechanically) couples with a mechanical indicator of the electromechanical contactor. The mechanical indicator moves from one physical position to another when the main conducting contacts of the electromechanical contactor change position, allowing the safety component to detect the position of the conducting contacts via the coupling between the mechanical indicator and the mechanical sensor. The safety component provides safety functions based on the state of the electromechanical contactor.

In some scenarios, a system includes an electromechanical contactor and a safety component. The electromechanical contactor includes a coil that has an energized state and a de-energized state. When the coil is in an energized state, it generates an electromagnetic force. The electromechanical contactor includes main contacts with an open position corresponding to the de-energized state of the coil and a conducting position corresponding to the coil's energized state. The electromechanical contactor further includes a mechanical indicator, as described in the preceding paragraph. The mechanical indicator has a first state that indicates that the main contacts are in the conducting position and a second state that indicates that the main contacts are in the open position. The safety component of the system includes a sensor that physically couples with the mechanical indicator. The safety component further includes safety circuitry coupled with the sensor configured to provide a safety function that impacts electrical energy transmission to a load connected to the main contacts of the electromechanical contactor.

In some scenarios, the electromechanical contactor further includes feedback circuitry. In such scenarios, the safety component is configured to generate a safety signal based on the electromechanical contactor's operational characteristics and transmit it to the electromechanical contactor via the feedback circuitry.

In some scenarios, the safety circuitry further includes a safety relay. In such scenarios, the electromechanical contactor is configured to disrupt electrical energy transmission to the load in response to receiving the safety signal at the feedback circuitry.

In some scenarios, the safety circuitry further includes auxiliary ports. In some scenarios, the safety circuitry further includes a safety contactor. In some scenarios, the safety circuitry couples with one or more external devices via the auxiliary ports. In such scenarios, the safety circuitry is further configured to provide the safety signal to the one or more external devices via the auxiliary ports.

In some scenarios, the safety circuitry is further configured to provide a safety alert to the one or more external devices via the auxiliary ports. The safety circuitry provides the safety signal in response to detecting both that the coil is in the de-energized position and that, based on the state of the mechanical indicator, the main contacts are in the conducting position. In some such scenarios, one of the one or more external devices interrupts the electrical energy transmission received at the electromechanical contactor in response to receiving the safety alert.

In some scenarios, the safety component is detachable. In such scenarios, the safety component is one of multiple safety components, each associated with and configured to achieve a particular one of numerous safety standards (i.e., standards for functional safety of electrical, electronic, and programmable systems). In some scenarios, the standards include Safety Integrity Level 2 (SIL2), Safety Integrity Level 3 (SIL3), Category II, Category III, Performance Level D (PLd), and Performance Level E (PLe). In some scenarios, the safety standards can be found in International Electrotechnical Commission (IEC) 61508 and IEC 62061.

In some scenarios, the electromechanical contactor is a three-phase electromechanical contactor. In some scenarios, the electromechanical contactor has a voltage rating for alternating current signals between twenty-four and six hundred volts. In some scenarios, the electromechanical contactor has a voltage rating for direct current signals ranging between twelve and two-hundred-and-fifty volts.

In some scenarios, the electromechanical contactor is a National Electrical Manufacturers Association (NEMA) class electromechanical contactor. In some such scenarios, the NEMA class electromechanical contactor is a Bulletin 500 class electromechanical contactor.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in accordance with some embodiments of the present technology.

FIG. 2 illustrates an operational environment in further detail in accordance with some embodiments of the present technology.

FIG. 3 illustrates an operational scenario in accordance with some embodiments of the present technology.

FIG. 4 illustrates an operational environment in further detail in accordance with some embodiments of the present technology.

FIG. 5 illustrates an operational environment in further detail in accordance with some embodiments of the present technology.

FIG. 6 illustrates a three-phase electromechanical contactor in accordance with some embodiments of the present technology.

FIG. 7 illustrates an electromechanical contactor and multiple safety components in accordance with some embodiments of the present technology.

FIG. 8 illustrates motor control center unit views in accordance with some embodiments of the present technology.

FIG. 9 illustrates a mechanical coupling view of an electromechanical contactor and an auxiliary contact block in accordance with some embodiments of the present technology.

FIG. 10 illustrates movement of a mechanical coupling between an electromechanical contactor and an auxiliary contact block in accordance with some embodiments of the present technology.

### DETAILED DESCRIPTION

The systems and apparatuses disclosed herein provide for an electromechanical contactor with an integrated safety component having safety functions that impact electrical energy transmission to a load coupled with the electromechanical contactor. The safety component, which includes components configured to achieve one of several existing safety standards (i.e., standards for functional safety of electrical, electronic, and programmable systems), is integrated into the electromechanical contactor through auxiliary connection points of the contactor. A mechanical sensor of the safety component physically couples with a mechanical indicator of the electromechanical contactor. The mechanical indicator moves from one physical position to another when the main conducting contacts of the electromechanical contactor change position, allowing the safety component to detect the position of the conducting contacts via the coupling between the mechanical indicator and the mechanical sensor. The safety component provides safety functions based on the state of the electromechanical contactor.

In some embodiments, a system includes an electromechanical contactor and a safety component. The electromechanical contactor includes a coil that has an energized state and a de-energized state. When the coil is in an energized state, it generates an electromagnetic force. The electromechanical contactor includes main contacts with an open position corresponding to the de-energized state of the coil and a conducting position corresponding to the coil's energized state. The electromechanical contactor further includes a mechanical indicator, as described in the preceding paragraph. The mechanical indicator has a first state that indicates that the main contacts are in the conducting position and a second state that indicates that the main contacts are in the open position. The safety component of the system includes a sensor that physically couples with the mechanical indicator. The safety component further includes safety circuitry coupled with the sensor configured to provide a safety function that impacts electrical energy transmission to a load connected to the main contacts of the electromechanical contactor.

In some embodiments, the electromechanical contactor further includes feedback circuitry. In such embodiments, the safety component is configured to generate a safety signal based on the electromechanical contactor's operational characteristics and transmit it to the electromechanical contactor via the feedback circuitry.

In some embodiments, the safety circuitry further includes a safety relay. In such embodiments, the electromechanical contactor is configured to disrupt electrical energy transmission to the load in response to receiving the safety signal at the feedback circuitry.

In some embodiments, the safety circuitry further includes auxiliary ports. In some embodiments, the safety circuitry further includes a safety contactor. In some embodiments, the safety circuitry is coupled with one or more external devices via the auxiliary ports. In such embodiments, the safety circuitry is further configured to provide the safety signal to the one or more external devices via the auxiliary ports.

In some embodiments, the safety circuitry is further configured to provide a safety alert to the one or more external devices via the auxiliary ports. The safety circuitry provides the safety signal in response to detecting both that the coil is in the de-energized position and that, based on the state of the mechanical indicator, the main contacts are in the conducting position. In some such embodiments, one of the one or more external devices interrupts the electrical energy transmission received at the electromechanical contactor in response to receiving the safety alert.

In some embodiments, the safety component is detachable. In some such embodiments, the safety component is one of multiple safety components, each associated with and configured to achieve a particular one of numerous safety standards (i.e., standards for functional safety of electrical, electronic, and programmable systems). In some embodiments, the safety standards include Safety Integrity Level 2 (SIL2), Safety Integrity Level 3 (SIL3), Category II, Category III, Performance Level D (PLd), and Performance Level E (PLe).

In some embodiments, the electromechanical contactor is a three-phase electromechanical contactor. In some embodiments, the electromechanical contactor has a voltage rating for alternating current signals between twenty-four and six hundred volts. In some embodiments, the electromechanical contactor has a voltage rating for direct current signals ranging between twelve and two-hundred-and-fifty volts.

In some embodiments, the electromechanical contactor is a National Electrical Manufacturers Association (NEMA) class electromechanical contactor. In some such embodiments, the NEMA class electromechanical contactor is a Bulletin 500 class electromechanical contactor.

The systems and apparatuses disclosed herein provide several technical effects, advantages, and/or improvements to electromagnetic contactors. For example, various embodiments of the disclosed technology provide for an electromechanical contactor and safety component system that occupies significantly less space than existing alternatives. As a result, operators in industrial environments can utilize the disclosed electromechanical contactor and safety component system in applications for which existing electromechanical contactor and safety component systems may be too large.

In another example, various embodiments of the disclosed technology provide for an electromechanical contactor and safety component system that uses less point-to-point wiring than existing alternatives. As a result, the disclosed electromechanical contactor and safety component systems can be implemented with less intricate wiring and fewer assembly steps, thereby reducing the risk of installation and maintenance issues.

In another example, various embodiments of the disclosed technology provide for an electromechanical contactor and safety component system where the safety component is detachable from the electromagnetic contactor. In such systems, the safety component is one of multiple safety components. Each of the multiple safety components and their constituent elements can be configured to achieve a safety standard (i.e., standards for functional safety of electrical, electronic, and programmable systems). An operator can select the safety component based on a particular safety standard and easily attach the safety component to the electromechanical contactor. As a further benefit, should an application require the satisfaction of a different safety standard, the safety component currently coupled with the electromechanical contactor can be detached, and a different safety component corresponding to the safety standard can be selected and installed to the electromechanical contactor.

Advantageously, the techniques described herein allow for the continued use of existing electromechanical contactors in applications where they might not otherwise be a sufficient selection. In particular, the systems described herein facilitate the continued use of trusted Bulletin 500 electromechanical contactors in applications where safety standards (i.e., standards for functional safety of electrical, electronic, and programmable systems) require certain operational characteristics that require additional elements or components. The safety components disclosed herein can be coupled to a Bulletin 500 electromechanical contactor while occupying significantly less physical space than would otherwise be occupied by traditional safety components wired to a Bulletin 500 electromechanical contactor. By extending the applicability of Bulletin 500 electromechanical contactors, the techniques herein facilitate efficient use of existing and well documented contactors (Bulletin 500) in scenarios with increasing restrictions on the space available for components where the components must achieve certain safety standards.

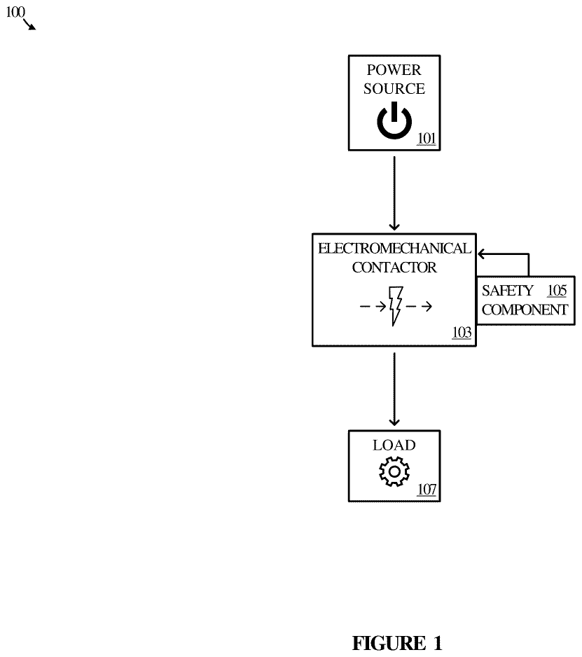

FIG. 1 illustrates operational environment 100 in accordance with some embodiments of the present technology. Operational environment 100 includes power source 101, electromechanical contactor 103, safety component 105, and load 107.

Operational environment 100 is generally representative of an environment in which an electromechanical contactor (e.g., electromechanical contactor 103) operates to provide switching functionality for an industrial load (e.g., load 107). Operational environment 100 may be an industrial environment that includes one or more motor control centers (MCC). In such embodiments, an operator may place electromechanical contactor 103 within an individual cabinet of the MCC (i.e., a unit of the MCC).

Power source 101 is generally representative of an industrial power source sufficient to provide the input signals required to drive an industrial load. Power source 101 may provide electrical energy as either an alternating or a direct current signal, depending on the industrial application to which power source 101 provides energy. In some cases, power source 101 may provide electrical energy via a single signal, while in others, power source 101 provides electrical energy via multiple phase-offset signals.

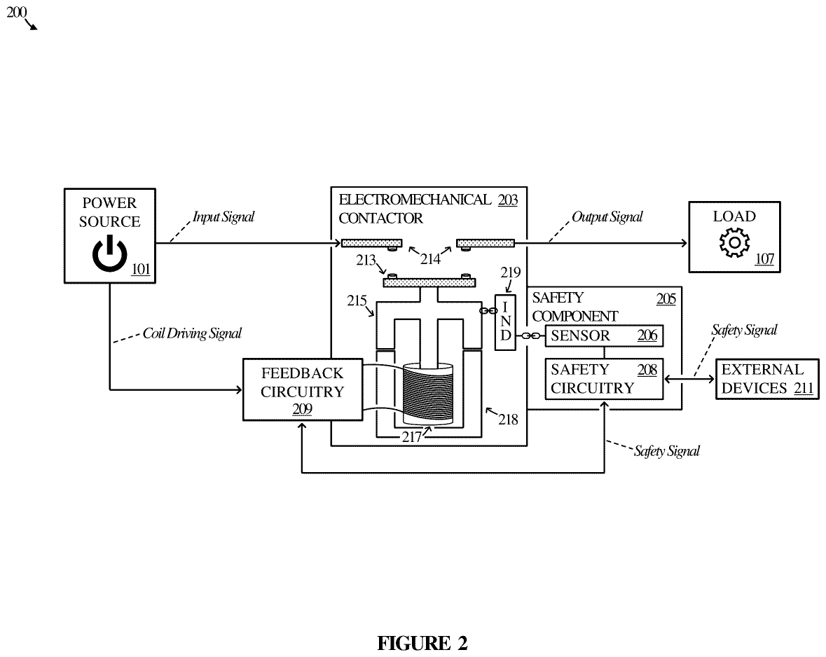

Electromechanical contactor 103 is generally representative of an electromechanical contactor that receives a signal (i.e., an input signal) from power source 101 and provides load 107 with the signal (i.e., an output signal) to drive load 107. Electromechanical contactor 103 provides operational environment 100 with switching functionality that either conducts electrical energy from power source 101 to load 107 or blocks the transmission of electrical energy to load 107. An example of such an electromechanical contactor in greater detail is provided by electromechanical contactor 203 of FIG. 2 and described in the associated text.

To provide load 107 with the electrical energy supplied by power source 101, electromechanical contactor 103 must be switched into a conducting state. A control signal is received at electromechanical contactor 103 that causes a coil to generate an electromagnetic force that overcomes gravity and drives a movable conducting element into contact with fixed upper contacts, allowing the flow of electrical energy to load 107. When electromechanical contactor 103 no longer receives the control signal, the coil no longer creates the electromagnetic force. With no electromechanical force driving the movable contacts upwards, gravity pulls the contacts back down and away from the fixed upper contacts, thereby disconnecting the contacts and disrupting the flow of electrical energy to load 107.

Safety component 105 is generally representative of a safety component that, when physically coupled with electromechanical contactor 103, combines with electromechanical contactor 103 to provide an electromechanical contactor with safety functions. In some embodiments, safety component 105 includes one or more of a sensor for detecting the position of a mechanical indicator of electromechanical contactor 103, safety circuitry for providing safety functions that impact the flow of electrical energy from power source 101 to load 107, a relay, a safety relay, a contactor, and a safety contactor. A safety contactor is an electromechanical contactor that has the same role and functionality as a standard electromechanical contactor except that the contacts for each phase of a safety electromechanical contactor are mechanically linked together such that the contact for each phase will close together and will fail into an open state (i.e., a normally-open configuration). A safety relay is a control device configured to implement safety functions (e.g., light curtains, safety mats, two-hand control devices, interlock safety switches, and the like). For example, the safety relay may provide one or more of input monitoring, safety output switching, fault detection (e.g., wiring errors, device failure, short circuits), redundancy (i.e., redundant circuits and self-monitoring features to ensure the safety relay itself functions properly), and standard compliance. In some embodiments, the safety circuitry of safety component 105 includes auxiliary ports. In some embodiments, the auxiliary ports can be coupled with one or more external devices not pictured in operational environment 100. In some embodiments, the functionality of the safety relay of safety component 105 is configured to achieve various international electrical technology safety standards, such as the standards given by International Electrotechnical Commission (IEC) 62061 and International Organization for Standardization (ISO) 12849.

Load 107 generally is generally representative of an industrial load driven by electrical energy generated at power source 101. Load 107 may be a high-voltage load that requires a high-voltage driving signal. In some cases, load 107 is an industrial motor. In some cases, a direct-current signal drives load 107, while in other cases, a direct-current signal drives load 107. In some cases, a three-phase signal provided by power source 101 drives load 107. In such scenarios, electromechanical contactor 103 may be a three-phase electromechanical contactor.

FIG. 2 illustrates operational environment 200 depicting further detail in accordance with some embodiments of the present technology. Operational environment 200 includes power source 101, electromechanical contactor 203, safety component 205, load 107, feedback circuitry 209, and external devices 211. Electromechanical contactor 203 includes lower contacts 213, upper contacts 214, upper core 215, coil 217, lower core 218, and mechanical indicator 219. Safety component 205 includes sensor 206 and safety circuitry 208. Each of power source 101 and load 107 are of FIG. 1 and are described in detail in the text associated with FIG. 1.

Electromechanical contactor 203 is generally representative of an electromechanical contactor that receives a signal (i.e., an input signal) from power source 101 and provides load 107 with the signal (i.e., an output signal) to drive load 107. Electromechanical contactor 203 provides operational environment 100 with switching functionality that either conducts electrical energy from power source 101 to load 107 or blocks the transmission of electrical energy to load 107.

Safety circuitry 208 is generally representative of a collection of electrical components configured to integrate with an electromechanical contactor to provide safety functionality. When coupled with safety circuitry 208, an electromechanical contactor may be operated in a manner that satisfies various safety standards (i.e., standards for functional safety of electrical, electronic, and programmable systems). Safety circuitry 208 may include a number of different electrical components, such as a safety relay, a safety contactor, or a combination thereof.

In some embodiments, safety circuitry 208 includes a safety relay, which is a device configured to monitor safety-related inputs (e.g., emergency stop buttons, interlocks, or presence-sensing devices) and to responsively selectively de-energize connected actuators upon detection of a fault or unsafe condition. To detect the fault or unsafe condition in such an embodiment, safety circuitry 208 may be connected to various sensors and other devices that inform safety circuitry 208 of a problem. When safety circuitry 208 is informed of the problem, safety circuitry 208 can interact with feedback circuitry (e.g., feedback circuitry 209) to deenergize electromechanical contactor 203 and interrupt the flow of electrical energy through electromechanical contactor 203.

Safety circuitry 208 may further include a safety contactor, which is a contactor comprising mechanically linked, force-guided contacts that enable detection of welding or contact failure. Safety contactors may be certified to operate in accordance with high-integrity electrical technology safety standards such as SIL 3 or PLe. In some implementations, safety circuitry 208 may also include dual-channel input paths to support redundancy and fault detection, cross-fault monitoring logic, and feedback circuits configured to confirm proper contactor state prior to re-energization. As a whole, safety circuitry 208 is operative to ensure controlled and verifiable interruption of hazardous energy sources in accordance with safety protocols.

Feedback circuitry 209 is generally representative of feedback circuitry that, in response to receiving a safety signal from safety circuitry 208, manages whether or not the control signal reaches coil 217. External devices 211 are generally representative of other devices in operational environment 200 that provide safety circuitry 208 with additional safety information relating to electromechanical contactor 203. External devices 211 may include sensors, control terminals, programmable logic controllers, etc. One example of such a sensor is a light curtain, which detects movement through a particular plane in space.

Lower contacts 213 is generally representative of a conductive element that, when placed into physical contact with upper contacts 214, allows the transmission of electrical energy from power source 101 to load 107. Lower contacts 213 are mounted on but electrically isolated from a movable element, represented by upper core 215. Upper contacts 214 (both the instance coupled with power source 101 and the instance coupled with load 107) are fixed in place such that when lower contacts 213 are raised into contact with upper contacts 214, a conductive pathway is formed, and electrical energy begins to flow from power source 101 to load 107.

To put electromechanical contactor 203 into a conducting state, upper core 215 is raised upwards to bring lower contacts 213 into physical contact with upper contacts 214. In a default state, gravity draws upper core 215 into a lowered position, separating lower contacts 213 and upper contacts 214. Because electromechanical contactor 203 is forced into a non-conducting state by gravity as a default state, electromechanical contactor 203 can be referred to as a normally-open contactor with a vertical lift-gravity drop out design. Generally, an electromechanical contact with a vertical lift-gravity drop out design is intended to be mounted to a vertical surface such that the operation of upper core 215 occurs in a vertical motion parallel to the mounting orientation. In such implementations, the energization of coil 217 forces upper core 215, and therefore lower contacts 213, upwards in the vertical direction into physical contact with upper contacts 214, creating a conductive pathway through electromechanical contactor 203. When coil 217 is no longer energized, upper core 215 is no longer subject to an electromagnetic force that overcomes gravity to drive upper core 215 upwards. As a result, gravity draws upper core 215 back down in the vertical orientation, thereby separating upper contacts 214 and lower contacts 213 and disrupting the flow of electrical energy through electromechanical contactor 203.

In some implementations, electromechanical contactor 203 may have a different design. In some implementations, electromechanical contactor 203 is driven into a default state by the elastic potential of a spring or other element. For example, electromechanical contactor 203 may include movable contacts that are vertically positioned above stationary contacts, where the movable contacts are driven upwards and away from the stationary contacts by a spring. In such an example, the movable contacts are drawn downward into contact with the stationary contacts when a coil driving signal is applied to the coil. When subject to the coil driving signal, the coil generates an electromagnetic force that overcomes the elastic potential of the spring and pulls the movable contacts downward into physical contact with the stationary contacts. When the coil is deenergized, the spring forces the movable contacts upwards and out of contact with the stationary contacts, thereby breaking the conductive pathway.

Lower contacts 213 and upper contacts 214 are separated (i.e., open) by default, meaning electromechanical contactor 203 is non-conductive by default. In some other scenarios, the elements of electromechanical contactor 203 may conduct electrical energy between power source 101 and load 107 in the default state (i.e., a normally-closed contactor). Whether electromechanical contactor 203 is a normally-open or a normally-closed contactor will inform some of the logic for providing the safety features described for safety component 205.

To raise upper core 215 into a position that allows lower contacts 213 and upper contacts 214 to conduct electrical energy, gravitational potential must be overcome. To overcome the potential of gravity experienced by upper core 215 as a result of the vertical orientation of electromechanical contactor 203, a control signal is applied to coil 217. Coil 217 is generally representative of a conducting coil or solenoid that, when subject to a direct-current control signal, creates an effectively uniform magnetic field that applies a force to magnetically susceptible materials within that magnetic field. In particular, when coil 217 receives a control signal, the ensuing magnetic field created by coil 217 applies a mechanical force to upper core 215 that overcomes gravitational potential and forces upper core 215 into the raised position. As a result, the force generated at coil 217 pushes lower contacts 213 into physical contact with upper contacts 214, and electrical energy is permitted to flow to load 107.

When coil 217 is no longer subject to a control signal, coil 217 no longer creates the magnetic field and upper core 215 is no longer forced into the raised position, allowing gravity to draw upper core 215 back into the lowered position. In some embodiments, power source 101 generates the control signal received at coil 217. In some other embodiments, another element may generate and supply coil 217 with the control signal.

Mechanical indicator 219 is generally representative of a physical element that indicates the state of upper core 215 by virtue of the position of mechanical indicator 219. In particular, mechanical indicator 219 physically couples with upper core 215. When upper core 215 is in the lowered position, and lower contacts 213 and upper contacts 214 are separated (i.e., open), mechanical indicator 219 is forced into a lowered position (i.e., a first state) that is associated with the lack of a conductive pathway from power source 101 to load 107. When upper core 215 is in the raised position and lower contacts 213 and upper contacts 214 are in contact (i.e., closed), mechanical indicator 219 is forced into a raised position (i.e., a second state) that is associated with the presence of a conductive pathway from power source 101 to load 107.

Safety component 205 is generally representative of a safety component that, when physically coupled with electromechanical contactor 203, combines with electromechanical contactor 203 to provide an electromechanical contactor with safety functions. Safety component 205 includes sensor 206 and safety circuitry 208. Safety circuitry 208 communicatively couples with feedback circuitry 209 and external devices 211. In some implementations, safety circuitry 208 and external devices 211 are coupled via a networked connection. In such implementations, the safety signal may be a networked signal. In some implementations, safety circuitry 208 and external devices 211 are coupled via a hardwired connection. In such implementations, the safety signal may be a hardwired signal.

In some embodiments, safety circuitry 208 includes a safety relay; in others, safety circuitry 208 includes a safety contactor. In some other embodiments, safety circuitry 208 includes a safety relay and a safety contactor. In some implementations, safety component 205 couples with more than one instance of sensor 206 in order to provide diagnostic redundancy. In such cases, safety component 205 can leverage the state information from the multiple instances of sensor 206 in order to provide a higher integrity of diagnostic evaluation when compared with diagnostics based on feedback from a mechanical coupling to a single instance of sensor 206. In some implementations, safety component 205 physically couples with multiple electromechanical contactors and provides safety functions for the multiple electromechanical contactors that achieves various safety standards (i.e., standards for functional safety of electrical, electronic, and programmable systems), such as Safety Integrity Level 3 (SIL 3). In some implementations, safety component 205 is further configured to detect an issue with a load based on evaluation of back-EMF (electromagnetic fields) characteristics of the load. In such an example, safety circuitry 208 may detect that back-EMF for a particular load is not occurring as anticipated, indicating that an issue is present. For example, safety circuitry 208 may detect from a lack of anticipated back-EMF that a motor load is not operating as expected under the input signal being provided.

As illustrated in FIG. 2, safety circuitry 208 is coupled with sensor 206, which physically couples with mechanical indicator 219. Because mechanical indicator 219 is also physically coupled with upper core 215, state information regarding upper core 215 and, therefore, lower contacts 213 and upper contacts 214 is communicated to sensor 206 via the physical coupling to mechanical indicator 219. Sensor 206 then transmits state information for electromechanical contactor 203 to safety circuitry 208. In certain conditions, safety circuitry 208 generates a safety signal based at least partly on receiving the state information corresponding to electromechanical contactor 203. In some embodiments, safety circuitry 208 detects information about the control signal supplied to electromechanical contactor 203 via the connection to feedback circuitry 209. In some embodiments, safety circuitry 208 receives additional safety information from external devices 211. In some embodiments, safety circuitry 208 generates a safety signal based on one or more of information about electromechanical contactor 203, information about the control signal supplied to electromechanical contactor 203, and information provided by external devices 211.

For example, safety circuitry 208 may receive an indication from external devices 211 informing safety circuitry 208 that a safety zone has been violated concerning electromechanical contactor 203. For instance, external devices 211 may include a safety relay comprising a beam-break or light curtain system that detects when an operator has physically moved through a particular space, such as the entryway to a unit of an MCC. As a result of the safety zone violation, safety circuitry 208 sends a signal to feedback circuitry 209, directing feedback circuitry 209 to obstruct the control signal from reaching coil 217. In some cases, safety circuitry 208 sends a signal to power source 101, directing power source 101 to stop providing coil 217 with the control signal.

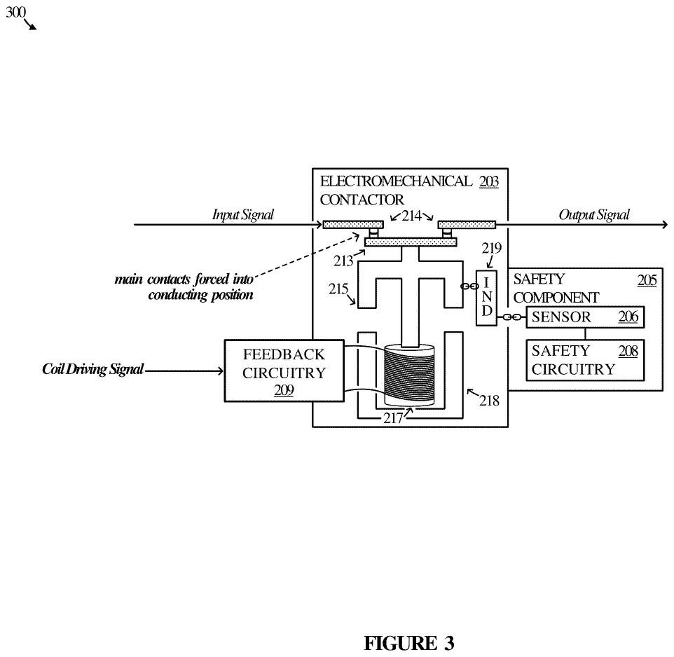

FIG. 3 illustrates operational scenario 300 in accordance with some embodiments of the present technology. Operational scenario 300 includes electromechanical contactor 203, feedback circuitry 209, and safety component 205. Electromechanical contactor 203 includes lower contacts 213, upper contacts 214, upper core 215, coil 217, lower core 218, and mechanical indicator 219. Safety component 205 includes sensor 206 and safety circuitry 208.

Each of electromechanical contactor 203, safety component 205, sensor 206, safety circuitry 208, feedback circuitry 209, lower contacts 213, upper contacts 214, upper core 215, coil 217, lower core 218, mechanical indicator 219, and sensor 206 are of FIG. 2 and are described in detail in the text associated with FIG. 2.

As illustrated in FIG. 3, coil 217 receives an energizing signal (i.e., a control signal) is received at coil 217 via feedback circuitry 209. As a result of the coil energizing signal, coil 217 generates an electromagnetic force that forces upper core 215 into the raised position, overcoming gravitational potential and bringing lower contacts 213 and upper contacts 214 into physical contact. As a result, electrical energy can now flow through the conductive pathway within electromechanical contactor 203.

The position of mechanical indicator 219, which physically couples with upper core 215, reflects that upper core 215 is drawn into the raised position. Therefore, the conductive pathway is formed by lower contacts 213 and upper contacts 214. Sensor 206 detects the position of mechanical indicator 219 through the physical coupling between sensor 206 and mechanical indicator 219. Sensor 206 can then inform safety circuitry 208 of the state of electromechanical contactor 203 to facilitate safety features for electromechanical contactor 203.

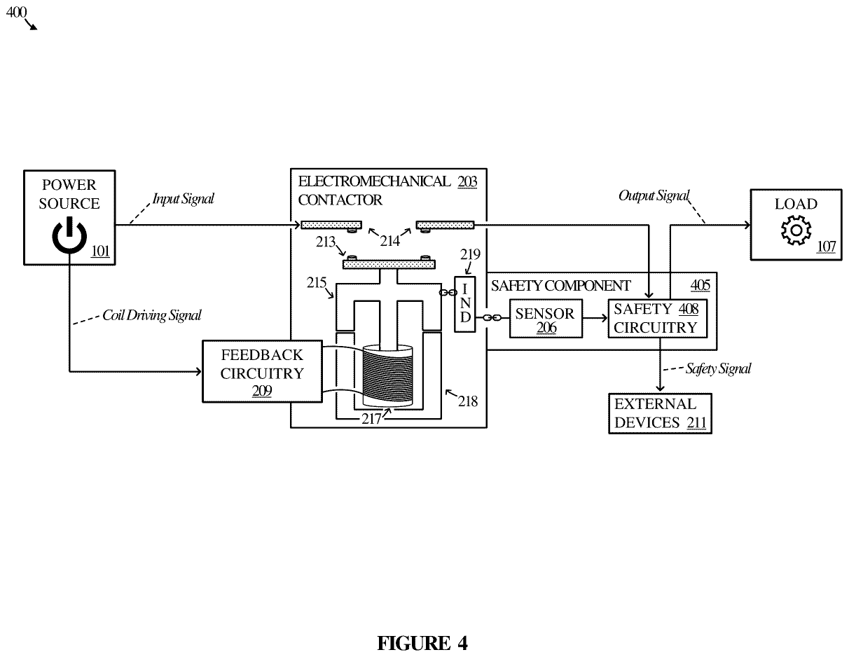

FIG. 4 illustrates operational environment 400, depicting further detail in accordance with some embodiments of the present technology. Operational environment 400 includes power source 101, electromechanical contactor 203, safety component 405, load 107, feedback circuitry 209, and external devices 211. Electromechanical contactor 203 includes lower contacts 213, upper contacts 214, upper core 215, coil 217, lower core 218, and mechanical indicator 219. Safety component 405 includes sensor 206 and safety circuitry 408.

Each of power source 101 and load 107 are of FIG. 1 and described in detail in the text associated with FIG. 1. Each of electromechanical contactor 203, feedback circuitry 209, lower contacts 213, upper contacts 214, upper core 215, coil 217, lower core 218, mechanical indicator 219, sensor 206, and external devices 211 are of FIG. 2 and are described in detail in the text associated with FIG. 2.

FIG. 4 differs from FIG. 3 and FIG. 2 in that operational environment 400 includes safety component 405. Safety component 405 is generally representative of a safety component that, when physically coupled with electromechanical contactor 203, combines with electromechanical contactor 203 to provide an electromechanical contactor with safety functions. Safety component 405 includes sensor 206 and safety circuitry 408. Safety circuitry 408 communicatively couples with external devices 211 to for communication.

Safety circuitry 408 is generally representative of circuitry that provides safety functions for electromechanical contactor 203 that impact the transmission of electrical energy through electromechanical contactor 203. In some examples of the embodiment illustrated here, safety circuitry 408 includes a safety contactor. A safety contactor is a contactor comprising mechanically linked, force-guided contacts that enable detection of welding or contact failure, and which may be certified to operate in accordance with high-integrity safety standards such as Safety Integrity Level 3 (SIL 3) or Performance Level E (PLe). For example, SIL3 systems typically require redundancy in critical components, such as electromechanical contacts and feedback circuitry, while PLe requires redundancy to the extent that the failure of no single component causes the loss of a safety function, the ability to detect faults, and the ability to respond to faults. As shown in operational environment 400, safety circuitry 408 receives the output signal supplied by electromechanical contactor 203, which safety circuitry 408 then supplies to load 107. In some embodiments, safety circuitry 408 obstructs the flow of electrical energy from reaching load 107 in response to receiving an indication of the state of electromechanical contactor 203 from sensor 206. In some cases, safety circuitry 408 generates a safety signal in response to receiving an indication of the state of electromechanical contactor 203 from sensor 206. In such cases, safety circuitry 408 transmits the safety signal to external devices 211. In some implementations, the safety signal is a networked signal where the coupling between safety circuitry 408 and external devices 211 is a network connection, while in some implementations the safety signal is a hardwired signal where the coupling between safety circuitry 408 and external devices 211 is a hardwired connection. In some scenarios, external devices 211 may impact the flow of electrical energy from power source 101 to electromechanical contactor 203 by directing power source 101 to stop providing the input signal.

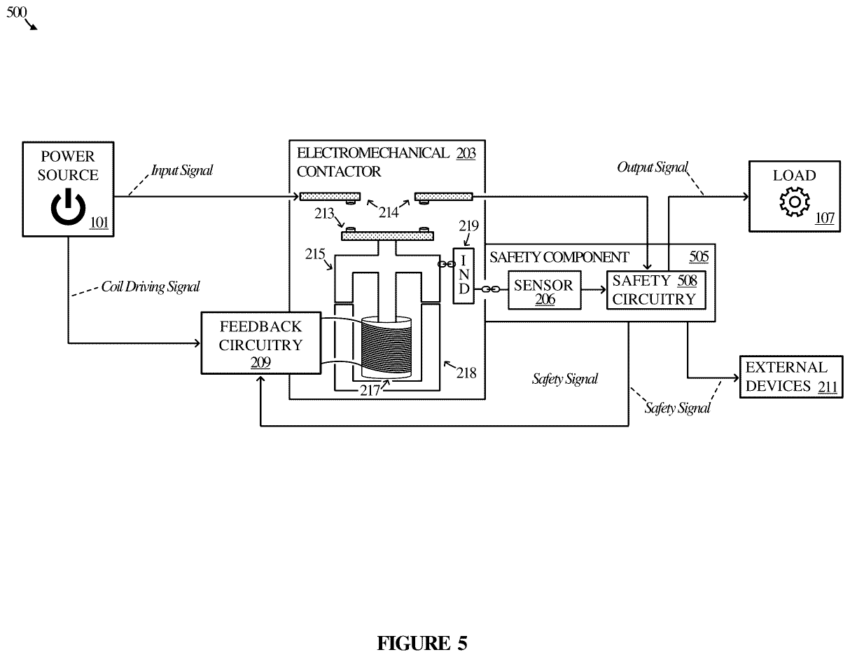

FIG. 5 illustrates operational environment 500 in further detail in accordance with some embodiments of the present technology. Operational environment 500 includes power source 101, electromechanical contactor 203, safety component 505, load 107, feedback circuitry 209, and external devices 211. Electromechanical contactor 203 includes lower contacts 213, upper contacts 214, upper core 215, coil 217, lower core 218, and mechanical indicator 219. Safety component 505 includes sensor 206 and safety circuitry 508.

Each of power source 101 and load 107 are of FIG. 1 and described in detail in the text associated with FIG. 1. Each of electromechanical contactor 203, feedback circuitry 209, lower contacts 213, upper contacts 214, upper core 215, coil 217, lower core 218, mechanical indicator 219, sensor 206, and external devices 211 are of FIG. 2 and are described in detail in the text associated with FIG. 2.

FIG. 5 differs from FIG. 4, FIG. 3, and FIG. 2 in that operational environment 500 includes safety component 505. Safety component 505 is generally representative of a safety component that, when physically coupled with electromechanical contactor 203, combines with electromechanical contactor 203 to provide an electromechanical contactor with safety functions. Safety component 505 includes sensor 206 and safety circuitry 508. Safety circuitry 508 communicatively couples to external devices 211 for communication. Safety component 505 may include circuitry that receives power from power source 101 and applies power to feedback circuitry 209 or to coil 217 in order to drive coil 217. In some implementations, safety component 505 includes more than one outputs for providing the safety signal to external devices 211. In some such implementations, the more than one output of safety component 505 may be redundantly communicated in series or may each be a simplex output.

Safety circuitry 508 is generally representative of circuitry that provides safety functions for electromechanical contactor 203 that impact the transmission of electrical energy through electromechanical contactor 203. In some examples of the embodiment illustrated here, safety circuitry 508 includes a safety relay and a safety contactor. As shown in operational environment 500, safety circuitry 508 receives the output signal supplied by electromechanical contactor 203, which safety circuitry 508 then supplies to load 107. In some embodiments, safety circuitry 408 obstructs the flow of electrical energy from reaching load 107 in response to receiving an indication of the state of electromechanical contactor 203 from sensor 206. In some cases, safety circuitry 408 generates a safety signal in response to receiving an indication of the state of electromechanical contactor 203 from sensor 206. In such cases, safety circuitry 408 may transmit the safety signal to external devices 211. In some scenarios, external devices 211 may impact the flow of electrical energy from power source 101 to electromechanical contactor 203 by directing power source 101 to stop providing the input signal.

Safety circuitry 508 is further communicatively coupled with feedback circuitry 209. Safety circuitry 508 can interact with feedback circuitry 209 to impact the transmission of a coil control signal to coil 217. Further, safety circuitry 508 can detect the presence of the control signal applied to coil 217 via the connection to feedback circuitry 209. This gives safety circuitry 508 a greater diagnostic scope concerning the operation of electromechanical contactor 203.

For example, safety circuitry 508 can determine, via the connection to feedback circuitry 209, that coil 217 is not subject to the coil energizing signal. As a result, coil 217 does not produce the electromagnetic force that overcomes gravitational potential and forces upper core 215 into the raised position. Safety circuitry 508 then detects, via sensor 206 and the physical coupling between sensor 206 and mechanical indicator 219, that upper core 215 remains in the raised position despite the lack of a coil control signal applied to coil 217. There are several reasons why upper core 215 would remain in the raised position while coil 217 is not producing the electromagnetic force that forces upper core 215 upward against the force of gravity. For instance, the conducting material of lower contacts 213 and upper contacts 214 may have overheated during operation and become partially or entirely fused.

This phenomenon, sometimes referred to as “welded contacts” in an electromechanical contactor, effectively holds electromechanical contactor 203 in the conducting state despite the normally-open default state of electromechanical contactor 203 and the lack of an energizing signal applied to coil 217. This phenomenon can create significant risk for the elements and operators of operational environment 500 due to the inability to disable the conducting pathway of electromechanical contactor 203. Welding or contact failure is detected by a mismatch of the coil driving signal and the position of lower contacts 213. Mechanical indicator 219 is monitored to report the position of electromechanical contactor 203. Mechanical indicator 219 is mechanically linked to upper core 215 such that mechanical indicator 219 can report an equivalent state. When the state of electromechanical contactor doesn't match the state of the coil driving signal for a specified period of time, a hardware fault has occurred. At this point, safety circuitry 508 will report the problem to external devices 211 via a safety signal. In FIG. 5, safety circuitry 508 can also be used to transition coil 217 into a safe state via feedback circuitry 209. As such, safety module 505 provides high integrity indications of the state of electromechanical contactor 203 that can be used to trigger safety functions in case of a hardware fault.

Continuing the above example, safety circuitry 508 is aware that upper core 215 is in the raised position (via sensor 206) and that coil 217 is not receiving the control signal and is, therefore, not producing electromagnetic force (via feedback circuitry 209). Safety circuitry 508 is configured such that when these two conditions coincide, an issue such as welded contacts has occurred. In some embodiments, safety circuitry 508 generates a safety alert in response to detecting the issue. The safety alert differs from the safety signal in that the safety alert indicates that a mechanical issue (e.g., welded contacts) has occurred within electromechanical contactor 203. Safety circuitry 508 sends the safety alert to external devices 211. In some embodiments, external devices 211 directs power source 101 to stop providing electrical energy to electromechanical contactor 203 to reduce the risk of not being able to disable the conducting pathway of electromechanical contactor 203.

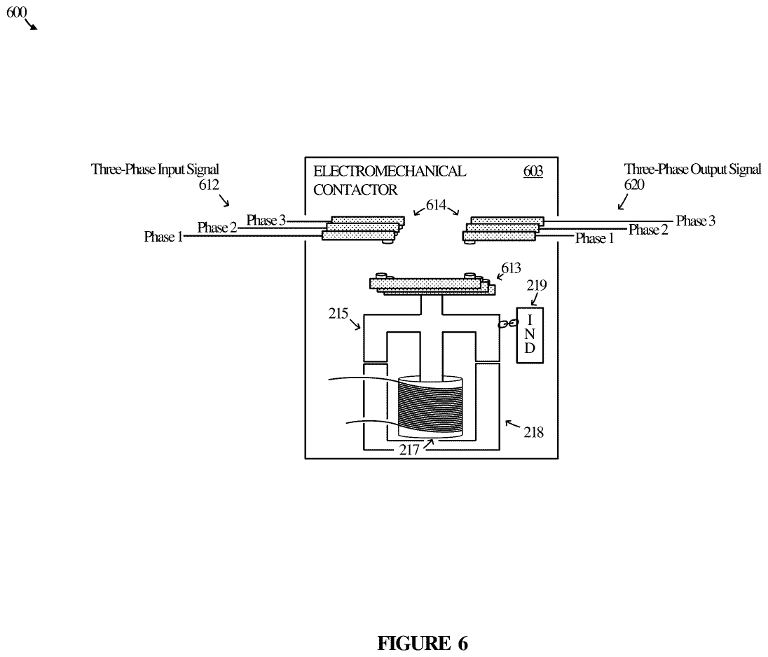

FIG. 6 illustrates three-phase electromechanical contactor 600 in accordance with some embodiments of the present technology. Three-phase electromechanical contactor 600 includes electromechanical contactor 603, three-phase input signal 612, and three-phase output signal 620. Electromechanical contactor 603 includes three-phase lower contacts 613, three-phase upper contacts 614, upper core 215, coil 217, lower core 218, and mechanical indicator 219. Each of upper core 215, coil 217, lower core 218, and mechanical indicator 219 are of FIG. 2 and are described in detail in the text associated with FIG. 2.

Electromechanical contactor 603 receives three-phase input signal 612 from a power source (e.g., power source 101 of FIG. 1) and provides switching functionality that facilitates transmission of three-phase output signal 620 to a load (e.g., load 107 of FIG. 1). Electromechanical contactor 603 includes coil 217 that, when energized by a control signal, produces an electromagnetic force that forces upper core 215 into the raised position.

Here, three-phase lower contacts 613 includes three conductive elements that are electrically isolated from each other. In some embodiments, each of the three conductive elements of three-phase lower contacts 613 forms an isolated conductive pathway that carries a signal of a particular phase offset. Three-phase upper contacts 614 includes three conductive elements that are electrically isolated from each other. In some embodiments, three-phase input signal 612 includes a phase one component, a phase two component, and a phase three component. In such embodiments, when upper core 215 is forced into the raised position, the three conductive elements of three-phase lower contacts 613 are raised into physical contact with the three conductive elements of three-phase upper contacts 614, both on the input and output sides of electromechanical contactor 603. In the raised position, three-phase lower contacts 613 and three-phase upper contacts 614 combine to form three isolated conductive pathways that support the transmission of three-phase input signal 612 from a three-phase power source into electromechanical contactor 603 and the transmission of three-phase output signal 620 out of electromechanical contactor 603 and to a three-phase load.

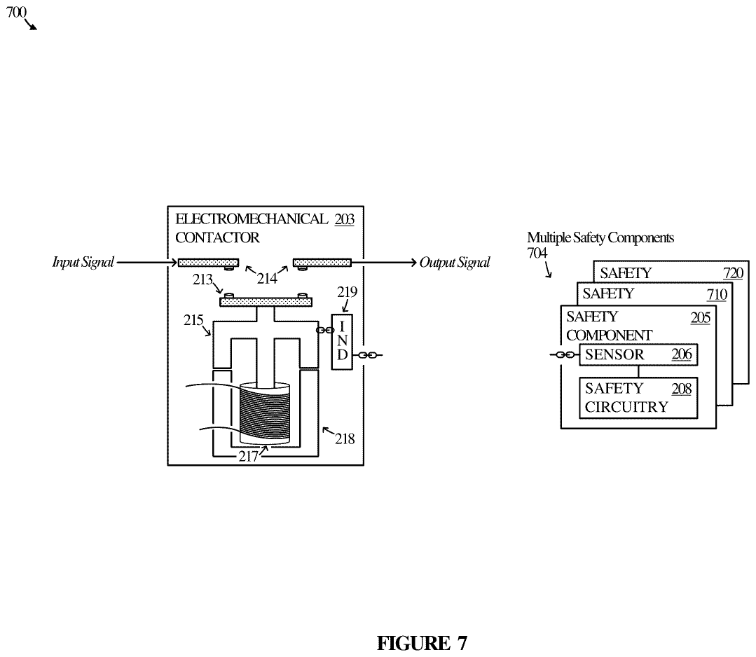

FIG. 7 illustrates electromechanical contactor and multiple safety components 700 in accordance with some embodiments of the present technology. Electromechanical contactor and multiple safety components 700 includes electromechanical contactor 203 and multiple safety components 704. Electromechanical contactor 203 includes lower contacts 213, upper contacts 214, upper core 215, coil 217, lower core 218, and mechanical indicator 219. Multiple safety components 704 includes safety component 205, safety component 710, and safety component 720. Each of electromechanical contactor 203, lower contacts 213, upper contacts 214, upper core 215, coil 217, lower core 218, mechanical indicator 219, safety component 205, sensor 206, and safety circuitry 208 are of FIG. 2 and described in detail in the text associated with FIG. 2.

Electromechanical contactor and multiple safety components 700 illustrates an embodiment of the disclosed technology where each of multiple safety components 704 are detachable from electromechanical contactor 203. Each of multiple safety components 704 physically couples with mechanical indicator 219 of electromechanical contactor 203. An operator can detach one of multiple safety components from electromechanical contactor 203, and another of multiple safety components 704 can attached instead. Each of multiple safety components 704 corresponds to a safety standard (i.e., standards for functional safety of electrical, electronic, and programmable systems). Each of multiple safety components 704 are configured to combine with electromechanical contactor 203 to provide a system that achieves the associated safety standard.

Safety standards may include Safety Integrity Level 2, Safety Integrity Level 3, Category 2, Category 3, Performance Level D (PLd), and Performance Level E (PLe). In an example where safety component 205 is associated with Safety Integrity Level 2, safety component 205 is configured to provide fault tolerance for single faults, some diagnostic functions, and some quantitative analysis. In an example where safety component 710 is associated with Safety Integrity Level 3, safety component 710 is rigorously designed and configured to provide a high degree of diagnostic coverage, redundancy, fault detection. In an example where safety component 710 is associated with Performance Level E (PLe), safety component 710 is configured to provide the highest level of electrical technology safety such that multiple faults do not result in a loss of safety functionality.

Beneficially, in such examples, where a system had previously been operating under the Safety Integrity Level 2 standard but subsequently must operate under the Safety Integrity Level 3 standard, safety component 205 can be detached from electromechanical contactor 203, and safety component 710 can be attached to electromechanical contactor 203 via the physical coupling to mechanical indicator 219. Further, safety component 720 may correspond to another electrical technology safety standard.

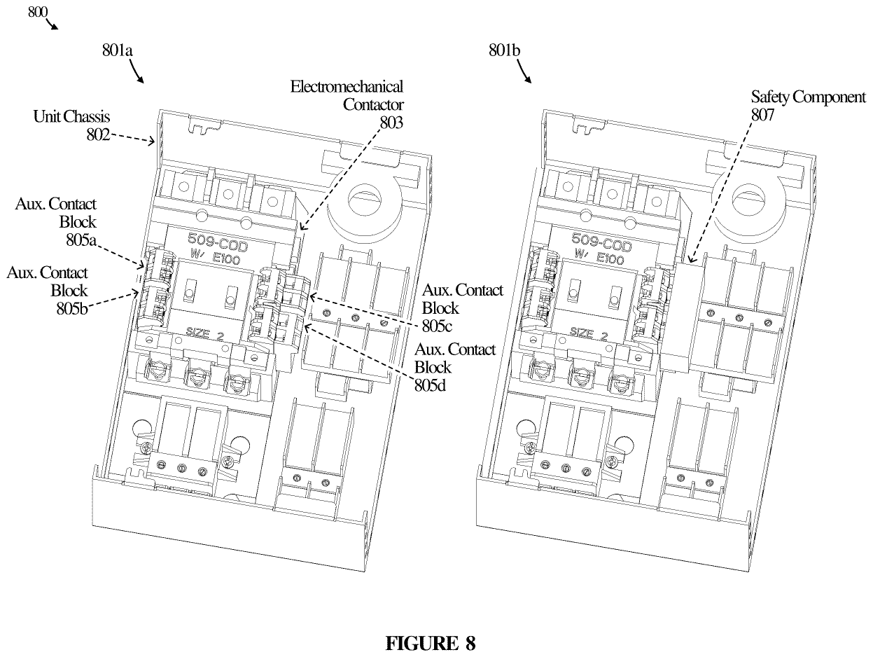

FIG. 8 illustrates motor control center unit views 800 in accordance with some embodiments of the present technology. Motor control center unit views 800 includes unit view 801a and unit view 801b. Unit view 801a includes unit chassis 802, electromechanical contactor 803, auxiliary contact block 805a, auxiliary contact block 805b, auxiliary contact block 805c, and auxiliary contact block 805d. Unit view 801b includes safety component 807.

Unit view 801a illustrates a collection of elements physically confined by unit chassis 802. Unit chassis 802 is configured to be a certain size such that unit chassis 802 and the components attached to unit chassis 802 can be placed into a unit cabinet of an MCC. Notably, unit chassis 802 may limit the space available for electromechanical contactor 803 and additional devices. Unit view 801a illustrates electromechanical contactor 803 having auxiliary contact block 805a and auxiliary contact block 805b on the left side and auxiliary contact block 805c and auxiliary contact block 805d on the right side. Electromechanical contactor 803 is representative of an electromechanical contactor for providing a load with electrical energy, an example of which is given by electromechanical contactor 203 of FIG. 2. Here, electromechanical contactor 803 is a Bulletin 500 class electromechanical contactor, which is a NEMA class electromechanical contactor. In some implementations, safety circuitry (e.g., safety component 205) couples with more than one auxiliary connection point of electromechanical contactor 803 in order to leverage feedback from more than one mechanical sensor of electromechanical contactor 803. In some implementations, the Bulletin 500 class electromechanical contactor is evaluated under electrical technology safety standards associated with mechanically linked contacts, while in some other implementations the Bulletin 500 class electromechanical contactor is evaluated under electrical technology safety standards associated with mirrored contacts. An example of a safety standard associated with mechanically linked contacts is given by the standard described in International Electrotechnical Commission (IEC) 60947-5-1, Annex L. An example of a safety standard associated with mirrored contacts is given by the standard described in International Electrotechnical Commission (IEC) 60947-4-1, Annex F.

As shown here, auxiliary contact block 805a-805d are generally representative of elements that mechanically couples with electromechanical contactor 803 via auxiliary connection points of electromechanical contactor 803. Auxiliary contact block 805a-805d are given as an example of how a device may physically couple with electromechanical contactor 803.

However, as shown in unit view 801a, electromechanical contactor 803 is not physically coupled with a safety component (e.g., safety component 807 of unit view 801b). Instead, generic auxiliary contact block (illustrated by auxiliary contact block 805a, auxiliary contact block 805b, auxiliary contact block 805c, and auxiliary contact block 805d) are coupled with electromechanical contactor 803. As a result, to achieve particular electrical technology safety standards in the scenario illustrated in unit view 801a, additional elements must be added to unit chassis 802 in the relatively small space that unit chassis 802 has or can be made available.

However, as shown in unit view 801b, safety component 807 has been added to unit chassis 802 in place of auxiliary contact block 805c and auxiliary contact block 805d and is now physically coupled with electromechanical contactor 803. To make space for safety component 807 at electromechanical contactor 803, auxiliary contact block 805c and auxiliary contact block 805d are detached from electromechanical contactor 803. Safety component 807 further includes safety auxiliary ports in the embodiment illustrated in FIG. 8. Beneficially, safety component 807 is attached to electromechanical contactor without the need for significant additional space in unit chassis 802 and without removing elements of unit chassis 802 except for auxiliary contact block 805b and auxiliary contact block 805d.

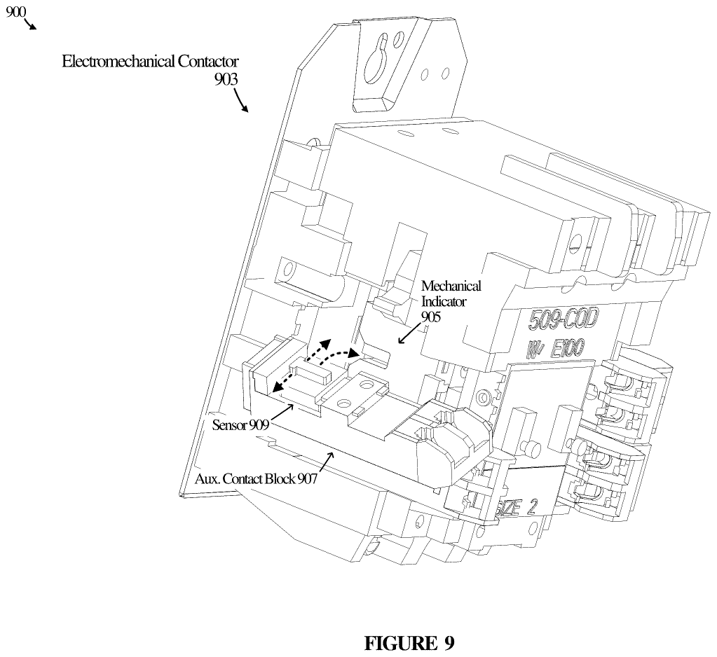

FIG. 9 illustrates mechanical coupling view 900 of an electromechanical contactor 903 and an auxiliary contact block 907 in accordance with some embodiments of the present technology. View 900 includes electromechanical contactor 903, which includes mechanical indicator 905, auxiliary contact block 907, and sensor 909.

Electromechanical contactor 903 is representative of an electromechanical contactor for providing a load with electrical energy, an example of which is given by electromechanical contactor 203 of FIG. 2. Here, electromechanical contactor 903 is a Bulletin 500 class electromechanical contactor, which is a NEMA class electromechanical contactor. The Bulletin 500 class electromechanical contactor is a proven electromechanical contactor that was originally developed decades ago and remains substantially the same as it was when it originally debuted.

View 900 illustrates a view of the side of electromechanical contactor 903 to show the detail of mechanical indicator 905 and the relationship between mechanical indicator 905 and sensor 909 of auxiliary contact block 907. Mechanical indicator 905 is representative of an indicator that physically changes position based on operational characteristics of electromechanical contactor 903, an example of which is given by mechanical indicator 219 of FIG. 2. Auxiliary contact block 907 are generally representative of an element that mechanically couples with electromechanical contactor 803 via auxiliary contact points of electromechanical contactor 903. Auxiliary contact block 907 is given as an example of how a device may physically couple with electromechanical contactor 803.

Sensor 909 is representative of a sensor capable of physically coupling with mechanical indicator 905 to detect the position of mechanical indicator 905 and to communicate the state information to another element. Sensor 909 is illustrated as an example of how a sensor might physically couple with a mechanical indicator, such as mechanical indicator 905.

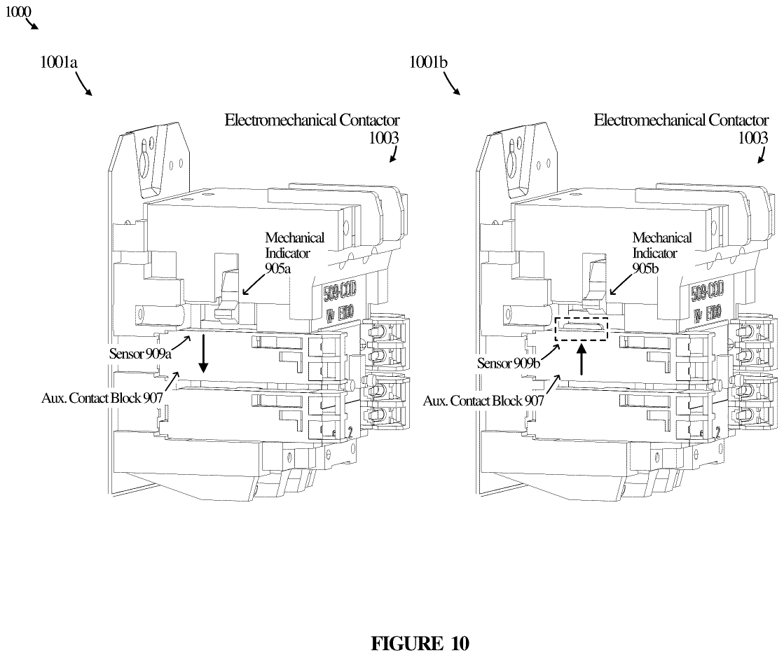

Here, sensor 909 can communicate state information for mechanical indicator 905 via auxiliary contacts of auxiliary contact block 907. Where sensor 909 is included in a safety component instead of auxiliary contact block 907, sensor 909 communicates state information for mechanical indicator 905 to the safety circuitry of the safety component. In any case, the physical coupling of sensor 909 and mechanical indicator 905 allows sensor 909 to detect the position of mechanical indicator 905. An example of the dynamic movement of mechanical indicator 905 and the corresponding movement of sensor 909 is illustrated in FIG. 10 and described in the associated text for FIG. 10.

FIG. 10 illustrates mechanical indicator views 1000 in accordance with some embodiments of the present technology. Mechanical indicator views 1000 includes view 1001a and view 1001b. View 1001a includes electromechanical contactor 1003, which further includes mechanical indicator 905a, auxiliary contact block 907, and sensor 909a. View 1001b includes electromechanical contactor 1003, which further includes mechanical indicator 905b, auxiliary contact block 907, and sensor 909b. In particular, FIG. 10 illustrates an example operation of a sensor of a generic auxiliary contact block, illustrated by sensor 909a and sensor 909b of auxiliary contact block 907.

Electromechanical contactor 1003 is representative of an electromechanical contactor for providing a load with electrical energy, an example of which is given by electromechanical contactor 203 of FIG. 2. Here, electromechanical contactor 1003 is a Bulletin 500 class electromechanical contactor, a NEMA class electromechanical contactor.

Views 1001a illustrates a view of the side of electromechanical contactor 1003 to show the detail of mechanical indicator 905a and the relationship between mechanical indicator 905 and sensor 909 of auxiliary contact block 907 when mechanical indicator 905a is in a first position. Mechanical indicator 905a is the same as mechanical indicator 905 of FIG. 9 except that mechanical indicator 905a is in a first state corresponding to the state of the conducting elements of electromechanical contactor 1003. Sensor 909a is the same as sensor 909 of FIG. 9 except that sensor 909a is shown from a different vantage point and is in a first state corresponding to the state of mechanical indicator 905a.

As shown in view 1001a, mechanical indicator 905a has been forced into the lowered position. In some embodiments, this corresponds to electromechanical contactor 1003 being in a conducting state, while in some embodiments, this corresponds to electromechanical contactor 1003 being in a non-conducting state. For example, concerning electromechanical contactor 203 of FIG. 2, the lowered position of mechanical indicator 219 that reflects the lowered position of upper core 215 corresponds to the lack of a conducting pathway formed in electromechanical contactor 203.

As a result of mechanical indicator 905a being in the lowered position, sensor 909a is in the lowered position. Sensor 909a can then communicate this state information to other devices or elements. For example, where sensor 909a is a component of a safety component (e.g., safety component 205 of FIG. 2), sensor 909a can communicate state information for electromechanical contactor 1003 to external devices (e.g., external devices 211) or feedback circuitry of electromechanical contactor 1003.

As shown in view 1001b, mechanical indicator 905b has been forced into the raised position. In some embodiments, this corresponds to electromechanical contactor 1003 being in a conducting state, while in some embodiments, this corresponds to electromechanical contactor 1003 being in a non-conducting state. For example, with respect to electromechanical contactor 203 of FIG. 2, the raised position of mechanical indicator 219 that reflects the raised position of upper core 215 corresponds to the presence of a conducting pathway in electromechanical contactor 203.

As a result of mechanical indicator 905b being in the raised position, sensor 909b is in the raised position. Sensor 909b can then communicate this state information to other devices or elements. For example, where sensor 909b is a component of a safety component (e.g., safety component 205 of FIG. 2), sensor 909b can communicate state information for electromechanical contactor 1003 to external devices (e.g., external devices 211) or feedback circuitry of electromechanical contactor 1003.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples of the technology are described above for illustrative purposes, various equivalent modifications are possible within the scope of the technology, as those skilled in the relevant art will recognize. For example, while processes or blocks are presented in a given order, alternative implementations may perform routines having steps or employ systems having blocks in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further, any specific numbers noted herein are only examples; alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above but also may include fewer elements.

These and other changes can be made to the technology in light of the above Detailed Description. While the above description describes certain examples of the technology and describes the best mode contemplated, no matter how detailed the above appears in the text, the technology can be practiced in many ways. Details of the system may vary considerably in its specific implementation while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification unless the above Detailed Description section explicitly defines such terms. Accordingly, the actual scope of the technology encompasses not only the disclosed examples but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim or in other forms, such as being embodied in a means-plus-function claim. Any claims intended to be treated under 35 U.S.C. § 112(f) will begin with the words “means for,” but the use of the term “for” in any other context is not intended to invoke treatment under 35 U.S.C. § 112(f). Accordingly, the applicant reserves the right to pursue additional claims after filing this application to pursue such additional claim forms in either this application or in a continuing application.

What is claimed is:

1. A system comprising:
an electromechanical contactor, comprising:
a coil comprising an energized state and a de-energized state, wherein the coil generates an electromagnetic force in the energized state,
main contacts, wherein the main contacts comprise an open position corresponding to the de-energized state of the coil and a conducting position corresponding to the energized state of the coil,
a mechanical indicator physically coupled to the main contacts, the mechanical indicator comprising:
a first state indicating the main contacts are in the conducting position, and
a second state indicating the main contacts are in the open position; and
a safety component, comprising:
a sensor physically coupled to the mechanical indicator, and
safety circuitry coupled to the sensor and configured to provide a safety function impacting electrical energy transmission to a load coupled to the main contacts.

2. The system of claim 1, wherein:
the electromechanical contactor further comprises feedback circuitry; and
the safety component is configured to:
generate, at the safety component, a safety signal based on operational characteristics of the electromechanical contactor, and
transmit the safety signal to the feedback circuitry.

3. The system of claim 2, wherein the safety circuitry further comprises a safety relay.

4. The system of claim 3, wherein the electromechanical contactor is configured to:
disrupt, in response to receiving the safety signal at the feedback circuitry, electrical energy transmission to the load.

5. The system of claim 2, wherein the safety circuitry comprises auxiliary ports.

6. The system of claim 5, wherein the safety circuitry further comprises a safety contactor.

7. The system of claim 6, wherein:
the safety circuitry is coupled with one or more external devices via the auxiliary ports; and
the safety circuitry is further configured to provide the safety signal to the one or more external devices via the auxiliary ports.

8. The system of claim 7, wherein the safety circuitry is further configured to provide, in response to detecting both that the coil is in the de-energized state and that, based on a state of the mechanical indicator, the main contacts are in the conducting position, a safety alert to the one or more external devices via the auxiliary ports.

9. The system of claim 8, wherein in response to receiving the safety alert, one of the one or more external devices interrupts the electrical energy transmission received at the electromechanical contactor.

10. The system of claim 1, wherein the safety component is detachable from the electromechanical contactor.

11. The system of claim 10, wherein the safety component is one of multiple safety components, wherein each of the multiple safety components are associated with a different one of multiple electrical technology standards.

12. The system of claim 11, wherein the multiple electrical technology standards comprise at least Safety Integrity Level 2, Safety Integrity Level 3, Category II, Category III, Performance Level D, and Performance Level E.

13. The system of claim 1, wherein the electromechanical contactor comprises a three-phase electromechanical contactor.

14. The system of claim 13, wherein:
the electromechanical contactor has a voltage rating for alternating current signals ranging between 24 volts and 600 volts; and
the electromechanical contactor has a voltage rating for direct current signals ranging between 12 volts and 250 volts.

15. The system of claim 13, wherein the electromechanical contactor comprises a National Electrical Manufacturers Association class electromechanical contactor.

16. The system of claim 15, wherein the National Electrical Manufacturers Association class electromechanical contactor comprises a Bulletin 500 class electromechanical contactor.

17. The system of claim 3, wherein the safety relay is configured to provide input monitoring, safety output switching, fault detection, and circuitry redundancy.

18. The system of claim 17, wherein the safety relay is further configured to:
detect a fault associated with the electromechanical contactor; and
in response, to force the electromechanical contactor into the open position.
